(19) United States
(12) Patent Application Publication
(10) Pub. No.: US 2018/0274739 A1
(43) Pub. Date: Sep. 27, 2018

(54) Flashlight formed at least in part of a carbon fiber material

(71) Applicant: Bill HO, Kowloon (HK)

(72) Inventor: Bill HO, Kowloon (HK)

(21) Appl. No.: 15/464,370

(22) Filed: Mar. 21, 2017

(51) Int. Cl. F21L 4/00; B32B 1/08; B32B 5/02; B32B 15/14; B32B 27/12; B32B 5/26; B32B 27/36; F21V 23/04

(52) U.S. Cl. CPC F21L 4/00; B32B 1/08; B32B 5/02; B32B 15/14; B32B 27/12; B32B 5/26; F21Y 2115/10; F21V 23/0421; B32B 2457/00; B32B 2262/101; B32B 2262/0269; B32B 2262/106; B32B 27/365

(57) ABSTRACT

The present invention is a flashlight formed at least in part of a carbon fiber material which comprises an elongated body, a head connected to a first end of the body, and an end cap connected to a second end of the body, wherein the body, the head and the end cap are formed at least in part of a carbon fiber material. As carbon fiber material is high in strength but light in weight in comparison to metal material, the present invention is capable of providing flashlights which could are both light in weight, tough and durable.

### BACKGROUND OF THE INVENTION

The present invention generally relates to a flashlight and more particularly to a flashlight formed at least in part of a carbon fiber material.

Flashlight casings are typically either made of metal or plastics. Metal casings are tough and durable but heavy in weight, thus reducing portability of the flashlights; plastic casings are light in weight but less durable. The marketplace therefore anticipates for flashlights which could are both light in weight, tough and durable.

### BRIEF SUMMARY OF THE INVENTION

The object of the present invention is to provide a flashlight formed at least in part of a carbon fiber material. As carbon fiber material is high in strength but light in weight in comparison to metal material, the present invention is capable of providing flashlights which could are both light in weight, tough and durable.

To attain this, the present invention comprises an elongated body, a head connected to a first end of the body, and an end cap connected to a second end of the body, wherein the body, the head and the end cap are formed at least in part of a carbon fiber material.

The carbon fiber material is in form of an outer carbon fiber layer bonded on an inner metal layer. The inner metal layer is composed of electrically conductive metal such as aluminum, stainless steel or copper. As an example, the inner metal layer is in form of a metal tube forming the body, and the outer carbon fiber layer is bonded to the metal tube by first winding a carbon fiber prepreg cloth on the metal tube, and then winding a sealing tape onto the carbon fiber prepreg cloth, and thereafter heating the metal tube to bond the carbon fiber prepreg cloth on the metal tube; the sealing tape is then removed and the metal tube bonded with the outer carbon fiber layer is polished and lacquered.

As the body, the head and the end cap are formed of an outer carbon fiber layer bonded to an inner metal layer, the head is electrically conductively connected to the body; the body is electrically conductively connected to the end cap; one or more batteries connected in series are disposed inside the body with a first end of the one or more batteries connected in series electrically conductively connected to the head and a second end of the one or more batteries connected in series electrically conductively connected to the end cap via a switch. In this way, the body is used for electrical conduction, thus simplifying the structure of the flashlight.

Alternatively, the carbon fiber material is in form of an outer carbon fiber layer bonded on an inner plastic layer. The inner plastic layer is composed of thermoplastic polymer such as polycarbonates (PC) or acrylonitrile butadiene styrene (ABS). As an example, the inner plastic layer is in form of a plastic tube forming the body, and the outer carbon fiber layer is bonded to the plastic tube by first winding a carbon fiber prepreg cloth on the plastic tube, and then winding a sealing tape onto the carbon fiber prepreg cloth, and thereafter heating the plastic tube to bond the carbon fiber prepreg cloth on the plastic tube; the sealing tape is then removed and the plastic tube bonded with the outer carbon fiber layer is polished and lacquered.

As the body is not used for electrical conduction, a battery casing is provided inside the body for electrical conduction with the head and the end cap.

Alternatively, the carbon fiber material is solely in form of a carbon fiber layer.

Optionally, a glass fiber layer or a Kevlar fiber layer is bonded to the outer carbon fiber layer or the carbon fiber layer for providing a multi-colored outlook.

### BRIEF DESCRIPTION OF THE DRAWINGS

FIG. 1 is a cross sectional diagram showing the structure of the first embodiment of the present invention.

FIG. 2 is an enlarged view of the portion marked “C” in FIG. 1.

FIG. 3 is a cross sectional diagram showing the structure of the second embodiment of the present invention.

FIG. 4 is an enlarged view of the portion marked “C” in FIG. 3.

### DETAILED DESCRIPTION OF THE INVENTION

The present invention will be explained in details below with reference to the accompanying drawings and specific embodiments:

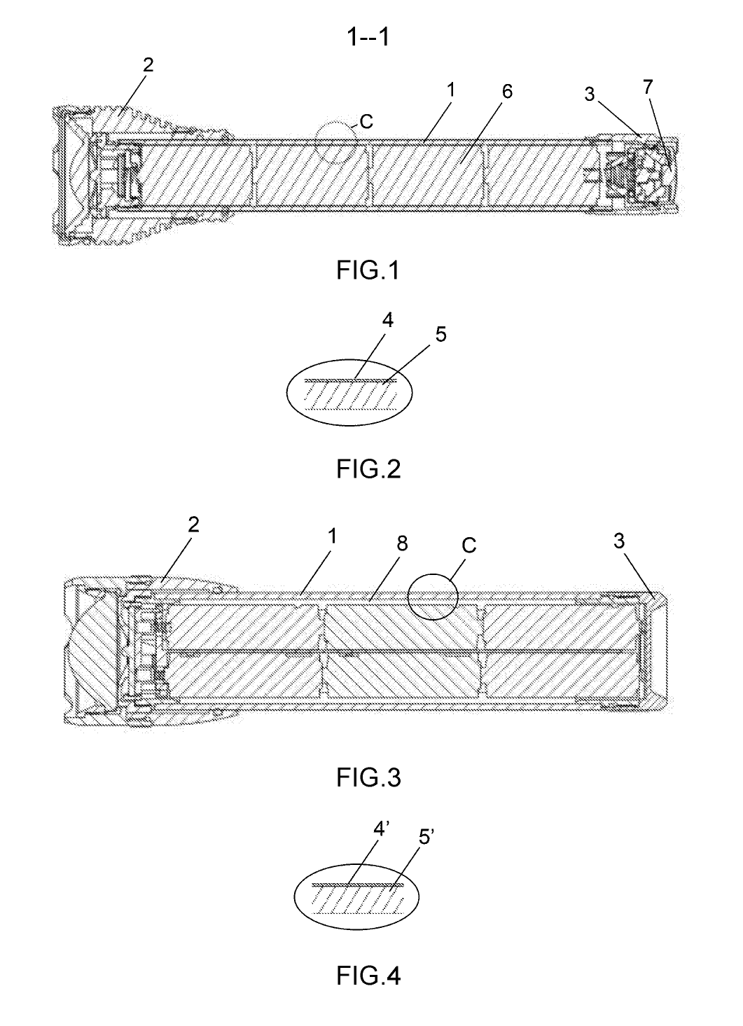

As illustrated in FIGS. 1 and 2, the first embodiment of the present invention comprises an elongated body 1, a head 2 connected to a first end of the body 1, and an end cap 3 connected to a second end of the body 1, wherein the body 1, the head 2 and the end cap 3 are formed at least in part of a carbon fiber material. In this embodiment, the carbon fiber material is in form of an outer carbon fiber layer 4 bonded on an inner metal layer 5. The inner metal layer 5 is composed of electrically conductive metal, which in this embodiment is stainless steel. The outer fiber layer 4 is bonded on the inner metal layer 5 by conventional means well known in the art. As an example, the inner metal layer 5 is in form of a metal tube forming the body 1, and the outer carbon fiber layer 4 is bonded to the metal tube by first winding a carbon fiber prepreg cloth on the metal tube, and then winding a sealing tape onto the carbon fiber prepreg cloth, and thereafter heating the metal tube to bond the carbon fiber prepreg cloth on the metal tube; the sealing tape is then removed and the metal tube bonded with the outer carbon fiber layer 4 is polished and lacquered. As the body 1, the head 2 and the end cap 3 are formed of an outer carbon fiber layer 4 bonded to an inner metal layer 5, the head 2 is electrically conductively connected to the body 1; the body 1 is electrically conductively connected to the end cap 3; four batteries connected in series 6 are disposed inside the body 1 with a first end of the four batteries connected in series 6 electrically conductively connected to the head 2 and a second end of the four batteries connected in series 6 electrically conductively connected to the end cap 3 via a switch 7. In this way, the body 1 is used for electrical conduction, thus simplifying the structure of the flashlight. A glass fiber layer is bonded to the outer carbon fiber layer 4 for providing a multi-colored outlook.

FIGS. 3 and 4 illustrate the second embodiment of the present invention which is substantially the same as the first embodiment except for the following: In this embodiment, the carbon fiber material is in form of an outer carbon fiber 4′ layer bonded on an inner plastic layer 5′. The inner plastic layer 5′ is composed of thermoplastic polymer which in this embodiment is polycarbonates (PC). The outer fiber layer 4′ is bonded on the inner plastic layer 5′ by conventional means well known in the art. As an example, the inner plastic layer 5′ is in form of a plastic tube forming the body 1, and the outer carbon fiber layer 4′ is bonded to the plastic tube by first winding a carbon fiber prepreg cloth on the plastic tube, and then winding a sealing tape onto the carbon fiber prepreg cloth, and thereafter heating the plastic tube to bond the carbon fiber prepreg cloth on the plastic tube; the sealing tape is then removed and the plastic tube bonded with the outer carbon fiber layer 4′ is polished and lacquered. As the body 1 is not used for electrical conduction, a battery casing 8 is provided inside the body for electrical conduction with the head 2 and the end cap 3. Various configurations of the battery casing 8 are well known in the art and thus the details thereof are not provided herein. In this embodiment, a Kevlar fiber layer is bonded to the outer carbon fiber layer 4′ for providing a multi-colored outlook.

The above embodiments are preferred forms of the present invention. However, the present invention is not limited by the above embodiments. Any substantive or fundamental changes, modifications, replacements, combinations or simplification within the spirit of the present invention are equivalent alternatives and they are all included in the scope of protection of the present invention.

What is claimed is:

1. A flashlight formed at least in part of a carbon fiber material which comprises an elongated body, a head connected to a first end of the body, and an end cap connected to a second end of the body, wherein the body, the head and the end cap are formed at least in part of a carbon fiber material.

2. The flashlight as in claim 1, wherein the carbon fiber material is in form of an outer carbon fiber layer bonded on an inner metal layer.

3. The flashlight as in claim 2, wherein the inner metal layer is composed of electrically conductive metal.

4. The flashlight as in claim 3, wherein the head is electrically conductively connected to the body; the body is electrically conductively connected to the end cap; one or more batteries connected in series are disposed inside the body with a first end of the one or more batteries connected in series electrically conductively connected to the head and a second end of the one or more batteries connected in series electrically conductively connected to the end cap via a switch.

5. The flashlight as in claim 1, wherein the carbon fiber material is in form of an outer carbon fiber layer bonded on an inner plastic layer.

6. The flashlight as in claim 5, wherein the inner plastic layer is composed of thermoplastic polymer.

7. The flashlight as in claim 6, wherein a battery casing is provided inside the body for electrical conduction with the head and the end cap.

8. The flashlight as in claim 1, wherein the carbon fiber material is solely in form of a carbon fiber layer.

9. The flashlight as in claim 2, wherein a glass fiber layer or a Kevlar fiber layer is bonded to the outer carbon fiber layer.

10. The flashlight as in claim 5, wherein a glass fiber layer or a Kevlar fiber layer is bonded to the outer carbon fiber layer.

11. The flashlight as in claim 8, wherein a glass fiber layer or a Kevlar fiber layer is bonded to the carbon fiber layer.
